(19) United States
(12) Patent Application Publication
(10) Pub. No.: US 2023/0062704 A1
(43) Pub. Date: Mar. 2, 2023

(54) VIDEO DECODING METHOD AND DEVICE ENABLING IMPROVED USER INTERACTION WITH VIDEO CONTENT

(71) Applicant: MOVI TECH AS, Oslo (NO)

(72) Inventors: Eike RÖSNER, Lommedalen (NO); Espen BJARNØ, Oslo (NO); Lars-Erik RAVN, Lier (NO)

(73) Assignee: MOVI TECH AS, Oslo (NO)

(21) Appl. No.: 17/797,577

(22) PCT Filed: Feb. 3, 2021
(86) PCT No.: PCT/NO2021/050034

§ 371 Date: Aug. 4, 2022

(30) Foreign Application Priority Data
Feb. 5, 2020 (NO) 20200151

(51) Int. Cl. H04N 19/177; H04N 19/159; H04N 19/44; H04N 19/423

(52) U.S. Cl. CPC H04N 19/177; H04N 19/159; H04N 19/44; H04N 19/423

(57) ABSTRACT

A method of managing the flow of data through a video decoder is described. The method includes receiving a stream of video data including compressed video frames organized in groups-of-pictures (GOP). A GOP typically includes one intra-frame coded image and a plurality of inter-frame coded images. Data included in received GOPs as uniquely identified GOP data blocks with uniquely identified compressed video frames are entered in a pre-decode cache module and they are selected, based on a current playback status, to be appended to a decode queue for GOP data blocks that will be delivered as input to a video decoder (106). Output data from the decoder (106) is delivered as decoded video frames to a post-decode cache module (303). Also described is a video decoder and a software program product.

### TECHNICAL FIELD

The present invention relates to video players and decoders, and in particular to a video decoder with improved user interaction with video content.

### BACKGROUND

Current video players are primarily made for passive video viewing. The user interface is modeled on the user interfaces of traditional physical video players (VCRs), which were again based on the user interface of audio cassette players and reel-to-reel tape recorders. Only to a limited degree have user gestures on touch screens or touch pads and camera-based hand gestures become part of the way users can interact with video playback.

Furthermore, video playback is based on a static presentation model where images are rendered at a predetermined frequency, playing linearly from beginning to end, and where fast forward or jump forward, or back, is based on rapid presentation of keyframes. End-users have no way to interact with, curate, edit or otherwise creatively interact with video content.

In view of the fact that users are accessing content from new types of devices, in new situations and with new ways of interacting with content, there is a need for video players that enable richer user interaction with video.

### SUMMARY OF THE DISCLOSURE

In order to meet some of the requirements that will enable users to interact more freely with video presentations, a method has been provided for managing the flow of data through a video decoder. The method includes receiving a stream of video data including compressed video frames organized in groups-of-pictures (GOP) with one intra-frame coded image and a plurality of inter-frame coded images, entering data included in received GOPs as uniquely identified GOP data blocks with uniquely identified compressed video frames in a pre-decode cache module, selecting, based on a current playback status, a uniquely identified GOP data block that has been entered in the pre-decode cache module, and appending the selected GOP data block to a decode queue for GOP data blocks that will be delivered as input to a video decoder. Data from decoded GOP data blocks that is delivered as output from the video decoder is entered as decoded video frames in a post-decode cache module.

In some embodiments the selection of which GOP data block to append to the decode queue is made by comparing information about available GOP data blocks currently stored in the pre-decode cache module with the current playback status and by providing an instruction to the pre-decode cache module identifying the selected GOP data block. The selection of which GOP data block to append to the decode queue may be performed each time a pre-defined criterion for a post-decode cache refresh is fulfilled. Multiple GOP data blocks may then be selected and appended to the decode queue when the post-decode cache refresh is performed.

The current playback position must be represented in some way in order to be available for comparison with information about available GOP data blocks. In embodiments of the invention the current playback status may include one or more parameters selected from the group consisting of: a current playback position in the video stream, a unique identification of a currently displayed video frame, a current playback speed, a current playback direction, received user input requesting a change in at least one of the currently displayed video frame, the current playback speed and the current playback direction, and playback status parameters stored in a remix file prior to a currently ongoing decoding of the stream of video data.

When the playback speed is increased, or for other reasons, it may be necessary to drop some frames from the video stream. In some embodiments of the invention this may be achieved by making a selection of a subset of the uniquely identified compressed video frames in the GOP data block when selecting a uniquely identified GOP data block. The method may then further comprise causing the video decoder to drop video frames from the GOP data block if they are not included in the selected subset. When uniquely identified compressed video frames are selected to be included in the subset, referenced video frames that are required for the decoding of referencing video frames in the same GOP may be prioritized, and video frames that are already available in the post-decode cache or currently being processed by the video decoder may be excluded.

The selection of uniquely identified GOP data blocks that have been entered in the pre-decode cache module to be appended to the decode queue may be based on a priority that is increased as a function of one or more of the following: the absence of required decoded video frames belonging to the GOP data block from the post-decode cache, the distance in time between a current playback time and the closest of the beginning and the end time of the GOP data block, a current playback direction, and an estimate of the likelihood of a change in playback direction.

Some embodiments of the invention include analyzing the received stream of video data in order to organize data related to the same GOP as uniquely identified GOP data blocks with uniquely identified compressed video frames. Data resulting from the analysis of the received stream of video data may then be embedded in the GOP data blocks when they are entered in the pre-decode cache module. The included information may be selected from the group consisting of a GOP start time, a GOP duration, a GOP end time, a video frame start time for each video frame, a video frame duration for each video frame, a video frame end time for each video frame, a data array correlating video frame decode sequence with video frame presentation sequence and, a data structure identifying referenced video frames that are required for decoding referencing video frames in the same GOP.

In some embodiments, memory may be dynamically allocated in the pre-decode cache module and the post-decode cache module. In the pre-decode cache module memory may be dynamically allocated to GOP data blocks from before and after the current playback position based on one or more of a current playback direction, a current playback speed, and a long-term prediction of the likelihood of change in playback direction or playback speed. Memory allocated to storing decoded video frames in the post-decode cache module may be dynamically allocated based on the same criteria but based on a short term prediction of the likelihood of change in playback direction or playback speed.

According to another aspect of the invention a video decoding device has been provided. The video decoding device is configured to perform a method for managing the flow of data and may include an input interface capable of receiving a stream of video data including compressed video frames organized in groups-of-pictures (GOP) with one intra-frame coded image and a plurality of inter-frame coded images, a stream analyzer configured to format data included in received GOPs as uniquely identified GOP data blocks with uniquely identified compressed video frames, a pre-decode cache module including a memory and configured to receive and store uniquely identified GOP data blocks and maintain a queue of such GOP data blocks to be decoded, a video decoding module including a processor, and a post-decode cache module including a memory and configured to receive data from decoded GOP data blocks delivered as output from the video decoder and to store the received decoded data blocks as decoded video frames in the post-decode cache module memory. The post-decode cache module may further be configured to select, based on a current playback status, a uniquely identified GOP data block that has been entered in the pre-decode cache module and cause the selected GOP data block to be appended to the decode queue for GOP data blocks that will be delivered as input to a video decoder.

In embodiments of the invention, information from the pre-decode cache module is made available to the post-decode cache module and vice versa. In various embodiments this may be done by transmitting messages or notifications between the two modules, by making the information available for look up from the modules, or by including an additional module that accesses and acts upon available information. Information from the pre-decode cache module may include information describing the content of a GOP data block when the GOP data block is received by the pre-decode cache module from the stream analyzer. The post-decode cache module may be further configured to make the selection of which GOP data block to append to the decode queue by comparing received description of GOP data blocks with the current playback status and the information from the post-decode cache modules to the pre-decode cache module may be or include an instruction identifying the selected GOP data block. It will be understood that the phrase “compare” in this context does not mean that they are examined in order to determine if they are “similar” or “the same.” Rather, the current playback status indicates or makes it possible to determine which GOP data blocks may be needed, and this is compared with availability in the pre-decode cache module.

The post-decode cache module may also be configured to make the selection of which GOP data block to append to the decode queue each time a pre-defined criterion for a post-decode cache refresh is fulfilled, and that multiple GOP data blocks are selected and appended to the decode queue when the post-decode cache refresh is performed.

The post-decode cache, when selecting GOP data blocks based on the current playback status may be configured to consider parameters selected from the group consisting of: a current playback position in the video stream, a unique identification of a currently displayed video frame, a current playback speed, a current playback direction, received user input requesting a change in at least one of the currently displayed video frame, the current playback speed and the current playback direction, and playback status parameters stored in a remix file prior to a currently ongoing decoding of the stream of video data.

In some embodiments the post-decode cache module is further configured to limit the selection of a uniquely identified GOP data block to a selected subset of the uniquely identified compressed video frames in the GOP data blocks. The video decoder may then be further configured to drop video frames from the GOP data block if they are not included in the selected subset. Dropping frames in this manner may be done in order to reduce the frame rate relative to the playback speed when playback speed is increased. The post-decode cache module may therefore be configured to reduce the size of the selected subset as a function of the current playback speed. In order to facilitate efficient decoding, the post-decode cache module may be configured to, when limiting the selection of a subset of video frames from a GOP data block, prioritize referenced video frames, i.e. frames that are required for the decoding of referencing video frames in the same GOP. Video frames that are already available in the post-decode cache or currently being processed by the video decoder, on the other hand, may be excluded.

The post-decode cache, when making the selection of a uniquely identified GOP data block to be appended to the decode queue, may further be configured make the selection based on prioritization criteria. As such, a data block's priority may be increased based on one or more of the following: the absence of required decoded video frames belonging to the GOP data block from the post-decode cache, the distance in time between a current playback time and the closest of the beginning and the end time of the GOP data block, the current playback direction, and an estimate of the likelihood of a change in playback direction.

The stream analyzer may, in some embodiments, be configured to analyze the received stream of video data and organize data related to the same GOP as uniquely identified GOP data blocks with uniquely identified compressed video frames, and to embed the data resulting from the analysis in the GOP data blocks when they are entered in the pre-decode cache module. The embedded data may thus include some or all of the information selected from the group consisting of: a GOP start time, a GOP duration, a GOP end time, a video frame start time for each video frame, a video frame duration for each video frame, a video frame end time for each video frame, a data array correlating video frame decode sequence with video frame presentation sequence and, a data structure identifying referenced video frames that are required for decoding other video frames in the same GOP.

The pre-decode cache module may be configured to dynamically allocate memory to GOP data blocks from before and after the current playback position based on one or more of a current playback direction, a current playback speed, and a long-term prediction of the likelihood of change in playback direction or playback speed. Similarly, the post-decode cache module may be configured to dynamically allocate memory to decoded video frames from before and after the current playback position based on one or more of a current playback direction, a current playback speed, and a short term prediction of the likelihood of a change in playback direction or playback speed.

Yet another aspect of the invention is a computer program product embedded in or carried by a computer readable medium and including instructions allowing a device to perform a method in accordance with the invention.

### BRIEF DESCRIPTION OF THE DRAWINGS

The invention will now be described in further detail by means of exemplary embodiments and with reference to the attached drawings.

FIG. 1 is an example of the pipeline of a typical video player;

FIG. 2 shows a sequence of video frames including an intra-coded frame and several inter-coded frames;

FIG. 3 shows an example of a video pipeline in a video player configured to operate in accordance with the invention;

FIG. 4 shows an example of how certain data may be structured in embodiments of the invention;

FIG. 5 shows how the pre-decode cache module may allocate memory;

FIG. 6 shows how the post-decode cache module may allocate memory;

FIG. 7 shows an example of the user interface of a video player device including user control elements;

FIG. 8 is a flowchart summarizing the flow of data through a device operating in accordance with the invention;

FIG. 9 is a flow chart illustrating a method of selecting GOP data blocks and frames that should be entered in the decode queue; and

FIG. 10 shows a block diagram of a device that may implement the invention.

### DETAILED DESCRIPTION

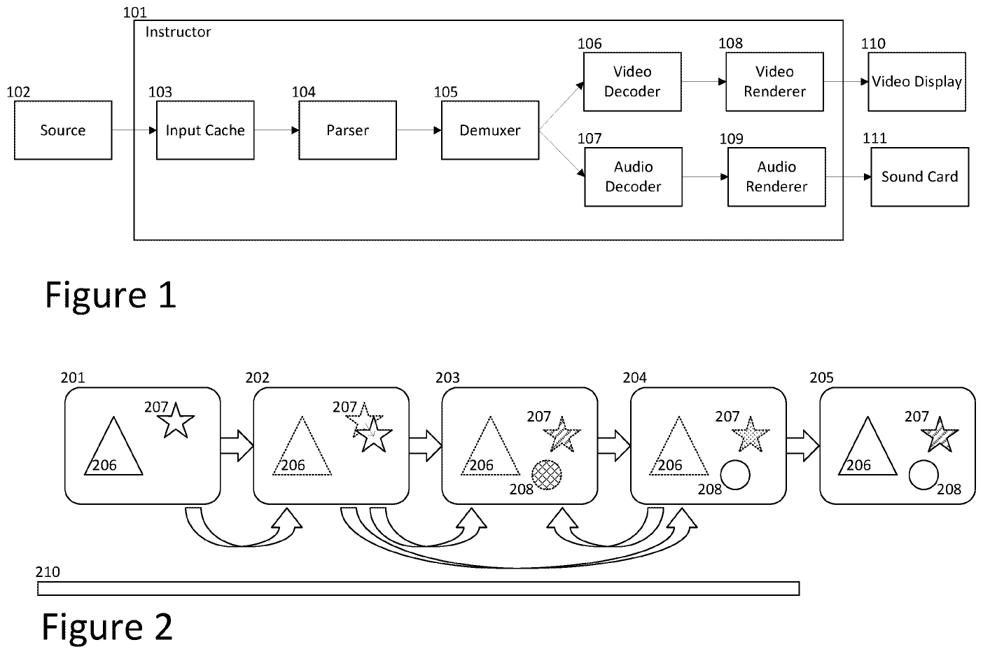

FIG. 1 shows an example of the pipeline of a typical current video player. Overall control of the pipeline, or at least of some of the functionality of the pipeline, is handled by an instructor 101, which may be managing the setup of the components based on input (e.g. file path), controlling the flow of data and provide the interface for the user allowing the user to control the playback using control elements such as play, pause, and seek. The instructor may, for example, provide a timer or clock signal for use by the components in the pipeline to synchronize audio and video. Components may then be able to forward content items such as video frames, audio samples and the like, downstream towards the output of the pipeline based on this time information and may drop items that contain old data.

The instructor 101 may set up a connection to a source 102 of media data. The source 102 may, for example, be a file or a video stream, and it may be locally stored or accessed from a remote location, for example the Internet.

The content data is received from the source 102 and entered into an input cache 103, the purpose of which is to serve as a buffer in order to ensure that content is available even if there is a delay in the delivery of content from the source 102, for example due to network latency. The cache itself may in some embodiments be a network cache. Following the cache 103 is a parser 104 which examines each received stream of content data in order to determine the media types included in the stream. The parser 104 may also be configured to detect or create segments, which is temporal sets of consecutive frames that belong together according to some criteria. Typically, a segment may be a camera shot or a scene. The parser may control which segments to downloaded from the source 102.

The parser 104 is followed by a demultiplexer, or demuxer 105, which demultiplexer video and audio data into two separate streams. The demuxer 105 may be a plugin which is loaded based on the determination of media types made by the parser 104. This makes it possible to add new media type capabilities to the video player by providing new plugins or updating existing plugins. The demuxer 105 sends video data to a video decoder 106 and audio data is sent to an audio decoder 107. Just like the demuxer, the decoders may be plugins chosen based on determination of media types by the parser 104. The decoders are followed by renderers, a video renderer 108 and an audio renderer 109, respectively. The renderers deliver output to the video display 110 and the sound card 111 of the device.

Video content is typically encoded using a video encoder and combined with audio content similarly encoded using an audio encoder. Examples of video coding formats include H.262 (MPEG-2 Part 2), MPEG-4 Part 2, H.264 (MPEG-4 Part 10), HEVC (H.265), Theora, RealVideo RV40, VP9, and AV1. Examples of audio coding formats include MP3, AAC, Vorbis, FLAC, and Opus. Video and audio is bundled inside a multimedia container such as AVI, MP4, FLV, RealMedia or Matroska. In the pipeline described above, the video and audio content is extracted from the container by the demuxer and directed to their respective decoders.

This pipeline is well suited for passive playback of media content but does not allow for any substantial user interaction apart from rapid feed forward and feed backward, and for jumps to specific positions in the video stream, a process referred to as seeking.

In order to better understand these shortcomings and how they are addressed by the present invention, it is useful to first describe how video is streamed.

Images in the sequence of images that together compose the complete video or movie are typically referred to as frames, and that terminology will be adopted herein. The image information contained in these frames is typically compressed using different algorithms. Some of these algorithms compress images without considering the content of other images, while other algorithms consider similarities from one image to the next and may also try to identify these similarities in other positions in a subsequent image, caused by motion. Coding based on the image information in only one frame is also called intra-frame coding, while coding based on information in several frames is called inter-frame coding.

Conversely, then, some compressed frames can be decompressed, or decoded, using only information relating to that frame, while other frames may require information from adjacent frames in order to be properly decoded. Individual frames will be referred to as frames in this disclosure whether they are uncompressed (prior to compression), compressed, or decompressed (subsequent to decoding in the video player). When required, and if not clear from the context, frames may be referred to as uncompressed frames, compressed frames, and decompressed frames. In addition, frames may be identified as being inter-frame or intra-frame.

Other terms that are used in this disclosure, such as messages, notifications, modules, interface, and other terms, may have specific meanings with respect to specific programming languages, programming paradigms or communication protocols. Unless otherwise noted, such specific meaning is not intended when these terms are used. Instead, the terminology adopted herein should be given a reasonably wide interpretation and be understood in a sense that is applicable to implementations across different platforms, standards, and paradigms. Some of the examples described below are described in terms of specific solutions. One example is the use of bitmasks to identify specific frames in a group of frames or pictures. It is in accordance with the invention to use other data structures than bitmasks for this purpose, and the use of bitmasks must be understood as exemplary.

It should further be understood that inasmuch as the invention relates to the flow of data through a video decoder, and not necessarily to the rendering of the decoded video data, playback, and in particular playback status, should be understood as the way data is streamed through the decoder and delivered to subsequent modules or stages that may ultimately result in rendering on a display, but that may equally well be handled in a different manner, for example written to a memory, transmitted to a remote device or handled in some other manner. As such, the current playback status is expressed in the form of data that in some way describes how data flows through the video decoder (e.g., relating to position, speed, direction), how this flow is changed based on user input (or a remix file, as will be described below), and possibly also predictions of how the flow might change. It should, however, be understood that such information may be expressed in the form of many different parameters, some of which may be derived from others, and that embodiments of the invention may use various combinations of the parameters described herein, or even parameters that are not explicitly mentioned herein but that are nevertheless derived from the same type of information.

As illustrated in FIG. 2, a sequence of video frames may include three different types of frames, I-frames, P-frames, and B-frames. The sequence in the drawing starts with a first I-frame 201, which includes two picture elements 206, 207. This frame is intra-coded, meaning it contains all information required to decode and render a complete image. The next frame is P-frame 202. This frame holds only the differences from the previous picture and can be decoded by applying those differences to the information from frame 201. In this case the triangle 206 is in the same position, while the star has moved. This may be encoded in frame 202 simply as a vector representing the movement of the star 207 and an identification of the star itself, for example as a particular block of pixels in the frame. Information that is not stored in this frame but derived from another frame is shown with dashed lines. The curved arrows below the frames indicate where the information for the elements shown with dashed lines come from.

In the next frame 203 none of the elements have moved, but the color of the star 207 has changed, and a new element, circle 208, has appeared. Again, the only new information that is required is the new color information for the star 207, the rest is available from other frames. However, this frame is a B-frame 203 and the new element, circle 208, is received from the next frame, which is P-frame 204. The circle 208 has a different color than in frame 204, and in this example, this change of color is the only information that is included in B-frame 203. Everything else is received from the adjacent P-frames 202, 204. This means that B-frame 203 cannot be completed until both adjacent P-frames 202, 204 are decoded. B-frames give even higher compression efficiency than P-frames, but require that all preceding as well as subsequent frames that, directly or indirectly, contribute information to the B-frame are downloaded and processed before the B-frame can be rendered.

The following frame is P-frame 204. This frame includes information specifying that the triangle 206 and the star 207 are unchanged from frame 202 and that an additional element, the circle 208, is added. This is the circle 208 that is referentially incorporated into frame 203 as described above.

The next frame is a new I-frame 205. In this case, I-frame 205 contains the same image as the preceding P-frame 204, but nevertheless all information is included in the frame and no information is referentially obtained from any other frame.

In summary, a frame that provides information to another frame is called a reference frame. A frame that is encoded and can be decoded without information from other frames is called an I-frame or an intra-frame. Frames that are encoded from a preceding reference frame are called P-frames, and frames that use information from two reference frames, one preceding and one subsequent frame, is called a B-frame. P-frames and B-frames can be reference frames, but the information they provide to other frames ultimately depend on information from an I-frame, since all information contained in P-frames and B-frames are descriptions of (cumulative) changes relative to an I-frame. Consequently, while P-frames can be decoded as soon as preceding frames have been received and decoded, B-frames have to wait for all subsequent reference frames. This establishes a decode sequence for the frames in a group of pictures that depend from one I-frame, and frames will typically be transmitted in the sequence they are to be decoded rather than the sequence in which they will be displayed.

I-frames are sometimes referred to as keyframes; a term borrowed from animation.

In the following disclosure, I-frames will be referred to as intra-frames and P-frames and B-frames will be referred to collectively as inter-frames.

The distance between two I-frames is referred to as the I-frame interval and is measured in number of inter-frames that occur between two I-frames. If the frame rate of a particular video is fixed the time between I-frames will be given by the I-frame interval divided by the frame rate. If, however, the video has variable frame rate, where the frame rate changes during a video or where individual frames are given a timestamp—the time between I-frames will depend on how often P-frames are currently being sent, which in turn may depend on the amount of changes in the scene. Scenes that vary only a little, especially when the video contains photos or a slideshow, will not require updates as often because of the mostly static information from frame to frame.

The frames included in an I-frame interval, i.e. the I-frame and all P-frames and B-frames that encode changes relative to the I-frame, may be referred to as a group of pictures (GOP). For videos with fixed frame rate the duration of a GOP is fixed. For video with variable frame rate, the duration of a GOP may vary. The first GOP in FIG. 2 includes the first four frames as illustrated by the bar 210 below them. I-frame 205 is the beginning of the next GOP. It should be noted that some video formats may include dependencies between GOP's. This may require additional considerations in order, for example, to keep track of how frames depend on each other, but it does not take anything away from the general principles of the invention.

Because of the properties of the stream of frames as a stream of GOP's with frames that depend on each other for decoding, and that ultimately depend on an initial intra-frame, the pipeline illustrated in FIG. 1 is not particularly suitable for sophisticated user manipulation.

Seeking is the process of configuring the pipeline for playback of media starting at a certain start time. When the instructor 101 receives an instruction to seek to another position in the stream it will adjust the global playback time, and it might issue a flush signal for the pipeline starting from the parser downwards. If the flush signal is issued all pending data in the pipeline is discarded and playback can start immediately from the new position. If no flush signal is issued, the seek is queued to be executed as soon as possible, which means that all data already in the pipeline may be played.

The instructor 101 instructs the file source to provide data starting from the last intra-frame prior to the time reeked to. This is necessary because jumping directly to the closest inter-frame would result in a stream that starts with information describing changes to an unknown intra-frame.

A consequence of this is that a pipeline like the one illustrated in FIG. 1 is that any seeking requires i) either flushing of the pipeline or queueing of the data from the seek point, ii) retrieval and decoding not only of the frames following the seek point, but all frames in the GOP in the appropriate decode order, starting with the intra-frame, and iii) for reverse playback this must be repeated for every GOP.

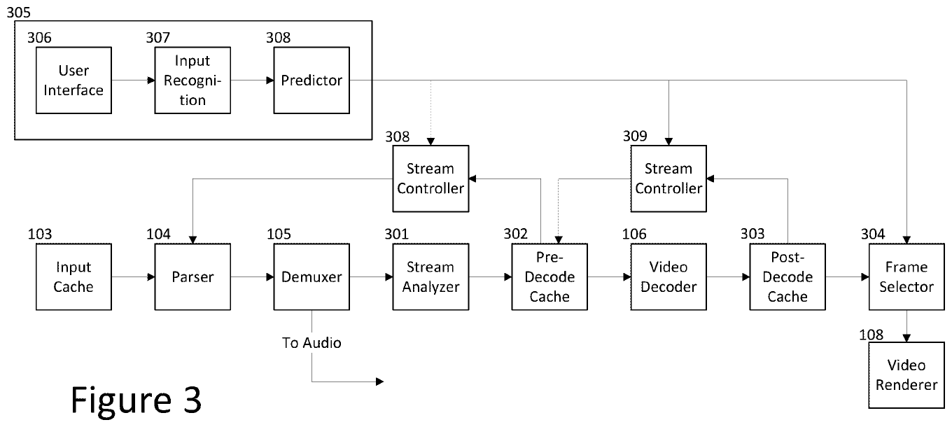

Reference is now made to FIG. 3, which illustrates an exemplary pipeline that is consistent with the principles of the present invention, and which alleviates some of the problems associated with user interaction with video. This pipeline includes the same modules as those described with reference to FIG. 1, but a number of additional modules introduces functionality that enables the user to manipulate the playback in many ways not possible or very difficult with other video players. For simplicity, the pipeline illustrated in FIG. 3 does not show the audio processing modules shown in FIG. 1, but they can be assumed to be present in the same manner, although it is, of course, possible to utilize the invention in video players without audio capabilities. The modules that are repeated from FIG. 1 have the same reference numbers, but that does not imply that they by necessity have to be exactly the same in terms of functionality, and some of the functionality provided by the present invention may be implemented in some of the modules that are common to the two figures or the repeated modules may have added functionality in order to allow them to operate smoothly with the added modules or with a user interface designed to take advantage of the improvements provided by the invention.

A first module that has been introduced in the embodiment of a pipeline illustrated in FIG. 3 is a stream analyzer 301. In the embodiment illustrated in the drawing, the stream analyzer 301 receives input from the demuxer 105 and can therefore be specific to the video decoder 106 chosen based on the determination of media type by the parser 104. A correspondingly chosen stream analyzer may be present in the demuxed audio stream not shown in this drawing.

As described above, a video stream typically consists of frames that are received in decoding order. For this purpose, they may be provided with a decode timestamp (DTS) and with a presentation time stamp (PTS), typically included in the container. The DTS will ensure that frames are decoded in the appropriate sequence, and the PTS will ensure that they are presented at the right time. The time given in the PTS is an absolute point in time in the media stream as a whole. The PTS enables synchronization of video and audio. The stream does not, however, include any information that explicitly specifies the duration of a frame (i.e. for how long the frame should be shown), or of a GOP.

The stream analyzer 301 is configured to restructure the media stream by storing all the compressed frames belonging to the same GOP in a GOP data block, determine the presentation order of the frames, and calculate the duration of each frame based on the PTS of the frame and the PTS of the following frame. Each GOP data block may include a reference table which includes the presentation order of the frames, the calculated duration of frames—or alternatively the end time for each frame, unique frame identifiers (UID), for example based on a UID of the block and each frame's sequence number in the GOP. Thus, the stream delivered as output from the stream analyzer 301 may include duration times (or end times) and presentation sequence stored in a table included in the GOP data block and readily available to the decoder 106. It should be noted that in principle, UIDs may be explicit or implicit (e.g., time stamps) and they may be present in the received stream or assigned or derived locally, for example by the stream analyzer 301.

The stream analyzer 301 may also establish a presentation-to-decode map, which may be an array associating decode index with presentation index. The following table and decode map are simplified illustrations that do not include presentation durations and where PTS and DTS start with zero, implying that this is the very first GOP data block in the video stream.

| | | | | | | |
|---|---|---|---|---|---|---|
| Decode index | 0 | 1 | 2 | 3 | 4 | 5 |
| Presentation index | 0 | 2 | 1 | 3 | 4 | 5 |
| PTS | 0 | 20 | 10 | 30 | 40 | 50 |
| DTS | 0 | 10 | 20 | 30 | 40 | 50 |

PresentationToDecodeMap={0=0, 1=2, 2−1, 3−3, 4−4, 5=5}

Each GOP data block may also include two bitmasks. Each bit in these bitmasks represents one of the frames in the GOP data block and they may be arranged in decode order. A first bit mask is a decode mask which indicates whether a given frame should be decoded. How the bits of the decode mask are set or modified will be described in further detail below. A second bit mask is a referenced mask which indicates whether the associated frame is referenced, i.e. whether it is needed in order to decode subsequent referencing frames. It should be noted that the term subsequent in this case refers to decode order, since no frame is needed in order to decode prior frames when they are arranged in decode order, but this does not have to be the case when they are ordered in presentation order. Frames that depend on a referenced frame may be referred to as referencing frames.

The stream analyzer 301 forwards the GOP data blocks to a pre-decode cache 302. | The pre-decode cache 302 will hold a number of GOP data blocks created by the stream analyzer 301. GOP data blocks will be forwarded to the video decoder 106 where they are decoded and delivered as a stream of decoded frames to a post-decode cache 303. The decoded frames are now in presentation order as determined by their PTS. It should be noted that GOP data blocks do not have to be forwarded as complete blocks, but may, for example, be forwarded frame by frame. This allows faster position changes during playback, since it will not be necessary to wait for the completion of entire GOP data blocks.

Decoded frames may now be delivered from the post-decode cache 303 to the video renderer 108. However, the invention allows users to manipulate the speed and direction of video playback in a manner that may require further selection of the decoded frames from the post-decode cache 303. For example, if the video is played at a significantly higher speed than normal it may be necessary to drop frames, and if the playback is suddenly reversed it becomes necessary to read frames out of the post-decode cache in the reverse order. For this purpose, a frame selector 304 may be provided at the output of the post-decode cache 303, and this frame selector selects the appropriate frames from the post-decode cache 303 and forwards them to the video renderer 108. In some embodiments the video frames may be decoded to an intermediate, compressed format by the video decoder 106. In these embodiments the frame selector 304 may be configured to perform the final decompression. Examples of intermediate formats are NV12 and I420, which are both well known in the art.

The frame selector operates under control of user input received from a user input system 305 including, in the illustrated embodiment, a user interface 306, an input recognition module 307 and a predictor 308. The predictor 308 provides an estimate, or prediction, of which parts of the media content will be required in the near future based on user input. Further details related to the operation of these modules will be presented below.

The frame selector 304 selects frames from the post-decode cache 303 based on input from the user input system 305. If the post-decode cache 303 is filled with decoded frames that have been provided based on an expectation of normal playback with display of all frames in their normal PTS order, the data available from the post-decode cache 303 may be inadequate if the user input system 305 instructs increased playback speed or repeated changes in playback direction. It may therefore be necessary to provide a different set of cached frames than the set resulting from simply caching frames a certain period ahead in time from the current playback position. This set may be selected based on some estimate, or prediction, of what the video renderer 108 will need in order to display the video in accordance with received and expected user input. In this exemplary embodiment this is handled by a combination of estimates generated by the input system 305, communication between the two cache modules 302, 303 regarding available and requested GOP data blocks and individual video frames, and two stream controllers 308, 309 configured to assist in the process of tracking availability of frames, GOPs and segments in different parts of the pipeline and handle requests for content. A first stream-controller 308 controls the parser 104 based on user input and on what is already present in the pre-decode cache 302, and a second stream-controller 309 controls the pre-decode cache 302 based on user input and what is already present in the post-decode cache 303.

As mentioned above, a GOP data block may include two bitmasks. The referenced mask can be created by the stream analyzer 301 based on information already present in the data received from the source 102. The decode mask, on the other hand, identifies frames that should be decoded—and conversely which frames can be dropped—based on what has been determined from user input, for a current playback status, and based on what may already be present in cache. This determination can be performed in the post-decode cache 303 based on input from the frame selector 304 and/or in the stream controller 309. The decode mask will then be communicated by the second stream controller 309 as a message from the post-decode cache 303 to the pre-decode cache 302 where it is stored as part of the GOP data block, as already described.

For each decoded GOP data block currently present in the post-decode cache 303 a bitmask is used to indicate which of the frames in this GOP data block are present in the post-decode cache 303, since frames may have been dropped. This bitmask, which may be maintained by the post-decode cache itself 303, or in some embodiments by the second stream controller 309, may be in presentation order since the decoded frames are in presentation order in the post-decode cache 303, and may be referred to as the DecodedFrames mask. Whenever a new GOP is added to the post-decode cache 303 a corresponding DecodedFrames mask is created and bits for all the frames from that GOP that have been decoded are set. The bits for frames that have been dropped, or that are later cleared from the post-decode cache 303 in order to free up memory, are unset. When the entire GOP is removed from cache the corresponding DecodedFrames mask is removed. The stream controller 309, or in some embodiments the post-decode cache 303, may also receive a notification from the pre-decode cache 302 each time a frame is forwarded from the pre-decode cache 302 to the video decoder 106. This makes it possible to maintain a bit mask which is used to keep track of the frames that are currently being decoded, i.e. currently being processed by the decoder 106.

Compressed frames will be forwarded to the decoder in decode order, but this bitmask, which may be referred to as the InDecoderMask, is based on frame identifiers and may therefore be in presentation order. The union of the DecodedFrames mask and the InDecoderMask, which may be created by a simple OR operation, provides a bitmask which may be referred to as the AvailableMask and which identifies all frames that are or will soon be available in decoded form in the post-decode cache 303, and therefore need not be requested.

Based on the current playback speed, as well as certain additional factors such as playback direction, post-decode cache 303 can determine which frames are needed. Default during forward playback at normal speed is that all frames are needed. However, as soon as playback speed increases it may be necessary to drop frames at a certain rate because it may be impossible, or at least too expensive in terms of cache memory and computation requirements, to display all frames at a very high rate, and also because it may be desirable to expand the time interval present in cache, something that will be described in further detail below.

For high frame rates it may thus be determined that frames should be dropped at a given rate based on playback speed. The exact drop rate may be a configurable parameter determined on various needs and variables, such as requirements dictated by the particular coding format, the availability of computation power and cache capacity, etc. A simple solution is to drop frames at a rate that is reciprocal to the increase in playback speed such that the rate of frames rendered remains constant. However, since increased playback speed will result in more rapid movement on the screen, it may be permissible to drop frames at a higher rate, since the rapid motion on screen will not be perceived as smooth and natural in any case, and this may at least partly reduce the effects of a higher drop rate and the resulting lower frame rate.

Conversely, if playback speed is reduced after playback has been running at an increased speed, GOP blocks may be present with only some frames in the post-decode cache 303. This means that it will not be necessary to decode the entire block once more; it may be sufficient to decode the missing frames, or perhaps even just some of the missing frames. Some embodiments of the invention may even implement the addition of frames created by interpolation if the playback speed is reduced a significant amount below normal playback speed.

Thus, when the post-decode cache 303 has determined which frames from a given GOP data block are needed, it can also determine which of the needed frames that are not available in the post-decode cache 303 or currently being decoded by the video decoder 106, as indicated by the availability mask. After this determination has been performed in the post-decode cache 303 the result is communicated back to the pre-decode cache 302 by the stream controller 309 as a message requesting a given subset of video frames from a given GOP data block. The information included in this request is used to set and/or unset the appropriate bits in the decode bitmask in the GOP data block.

The pre-decode cache 302 is thus controlled by the stream controller 309, based on a message generated by the post-decode cache 303, to deliver frames that are needed, but not yet decoded. In some embodiments the message from the post-decode cache 303 will only include requests for GOP data blocks and video frames that are known to be present in the pre-decode cache 302 based on information received from the pre-decode cache 302 (or the stream analyzer 301) when the GOP data block is delivered to the pre-decode cache 302. In alternative embodiments the post-decode cache may request any set of video frames from any GOP data block regardless of availability in the pre-decode cache. In the latter case frames that are requested but not available may generate requests for required segments by the first stream analyzer 308 to the parser 104. In either case, frames that are present in the pre-decode cache 302 will be entered in a decode queue to be forwarded to the video decoder 106.

The pre-decode cache 302 and the first stream controller 308 operate in a manner similar to the operation of the post decode cache 303 and the second stream controller 309, but on GOP data blocks and segments rather than frames and GOP data blocks. The pre-decode cache 302 maintains a list of all GOP data blocks that are currently cached in the pre-decode cache 302. Frames are normally not dropped prior to the video decoder 106, so the pre-decode cache will primarily store complete GOP data blocks. GOP data blocks may, however, be dropped from segments. GOP data blocks may, for example, be dropped from the beginning or the end of a segment due to limitations in cache size. In some embodiments frames may be dropped from GOP data blocks for the same reason.

The first stream controller 308 maintains a list of which segments are currently being downloaded or processed by the Parser 104, Demuxer 105 or StreamAnalyzer 301. These segments will progress towards the pre-decode cache 302 and eventually become available to the video decoder 106. If GOP data blocks that are required are not available, the first stream controller 308 will have available information indicating whether the segment including that data block has already been requested and is present in the pipeline. Segments that are required but not available, will have to be requested from the source 102, and the first stream controller 308 will instruct the parser 104 to obtain the segment. The parser 104 will then try to obtain the appropriate video segment from the input cache or request it from the source 102.

When a GOP data block that has been entered in the decode queue is at the head of that queue the pre-decode-cache 302 will forward the data block to the video decoder 106 frame by frame in decode order. If the bit corresponding to a given frame in the decode mask is not set, the frame will be dropped as soon as possible. Dropping the frame prior to decoding will reduce the amount of computation power required, but some video decoders may not be able to do this, in which case the decoded frame may be dropped rather than being entered in the post-decode cache 303. When this disclosure or the appended claims refer to dropping of video frames, or dropping of compressed frames, this is intended to include any dropping of frames between the pre-decode cache and the post-decode cache, whether or not the dropped frame has been subject to any decoding or other processing before it is dropped.

When a frame is marked to be dropped in the decode mask, its corresponding bit in the InDecoderMask will also be unset; it will be treated as if it is not present in the decoder regardless of where in the process the frame is actually dropped. As soon as there are no more set bits in the decode mask, the pre-decode cache 302 may start providing frames from the next GOP data block to the video decoder 106.

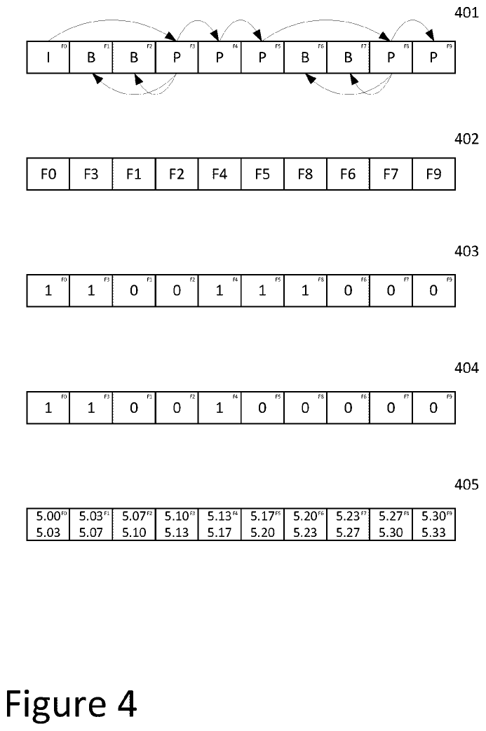

FIG. 4 shows an example of how the data described above may be structured in accordance with an embodiment of the invention. A GOP 401 includes, according to this example, ten frames F0-F9. The first frame is the keyframe F0, which is an intra-coded frame. It can be decoded based only on the data included in that compressed frame. The following two frames F1, F2 are inter-coded, meaning that they must receive data from a previously decoded frame before they can be decoded. Furthermore, they are B-frames since they depend on data from frame F3, a frame with a later presentation time. Frame F3 depends only on F0, and is thus a P-frame, as are the following two frames F4, which references F3, and F5 which references F4. The next two frames are B-frames F6, F7 which reference F8. The last two frames F8, F9 are P-frames.

A decode order that satisfies these dependencies are shown as decode order 402. Frames F1 and F2 may be decoded at any time and in any order after F3 has been decoded, and F6, F7 and F9 may be decoded at any time and in any order after F8 has been decoded, but apart from that the decode order is given by how inter-frames reference other frames. The relationship between decode order and presentation order may be stored in an array that maps decode order to presentation order as described above.

A referenced bitmask 403, which may be generated by the stream analyzer 301 and included in the GOP data block, identifies the frames that are referenced, i.e. frames that are required for decoding of other frames. In this example F0, F3, F4, F5, F8 are referenced. By including this information in the description of the GOP data block that is sent to the post-decode cache 303 by the pre-decode cache 302, the post-decode cache 303 can take this information into consideration when determining whether to drop frames. For example, since frame F4 is sandwiched between F3 and F5, it might be desirable to drop frame F4. However, since F4 is required for decoding of F5 this would make little sense. Instead, the obvious candidates for dropping would be frames F1, F2, F6, F7, F9, all of which are not needed for the decoding of other frames.

It may, of course, be desirable to drop more frames than the ones that are not referenced, in which case frames can safely be dropped from the end of the GOP when organized in decode order. The I-frame (or keyframe) may, of course, never be dropped except in the case where the entire GOP is dropped.

When the stream analyzer 301 generates the GOP data block and forwards it to the pre-decode cache 302, it may also include a decode bitmask as described above. The decode bitmask identifies which frames to decode and which frames to drop. As described above, this is something that may be determined by the post-decode cache module 303, so when the GOP data block is first generated this bit mask may be empty, or all bits may be set or unset. When the post-decode cache sends a request for the corresponding GOP to the pre-decode cache it may include an identification of a subset of frames, and this subset may be selected by setting the bits that correspond to the selected frames to 1 and the remaining (dropped) frames to 0 (or vice versa).

In this example the post-decode cache 303 has determined to drop all but three frames. It will be seen that this can be done by selecting frames F0, F3 and F4. Any other selection of three frames would require decoding of additional frames. The post-decode cache 303 may therefore set the decode bitmask 404 as shown in the drawing.

Additional information that may be calculated by the stream analyzer 301 and included in the GOP data block is the duration of individual frames. Typically, with respect to presentation a video stream only includes a presentation time stamp identifying the point in time in the global timeline of the entire video stream where the video frame should be displayed. The frame will then be displayed from the presentation time given and until it is replaced by a following frame as determined by the following frame's presentation time stamp.

In order to be able to play the video stream backwards, it is desirable to have the same information about the end time for a frame, which becomes the presentation time for the frame when the stream is played backwards. Furthermore, when prioritizing selection of frames or GOPs to decode based on the likelihood that the frame or the entire GOP data block will be required in the post-decode cache 303, it is desirable to know how distant the frame or GOP is in time given that the playback direction is left unchanged or suddenly changes.

The stream analyzer 301 may therefore include an array 405 or some other data structure in the GOP data block that stores not only the presentation time for each frame, but also the duration or the end time for each frame and/or for the entire GOP. It will be realized that when based on presentation time and duration, end time can be calculated, and based on presentation time and end time, duration can be calculated. It is therefore not necessary to store all three, since any one can be calculated from the two others when needed.

The exemplary array 405 shown in the drawing is based on the assumption that the GOP start 5 seconds into the video stream and displays a new video frame every 0.033 seconds, i.e. a frame rate of 30 fps. Each frame is associated with its presentation time and its end time, and the start time and end time of the GOP is the presentation time of the first frame, F0, namely at 5.00 seconds and the end time of the GOP is the end time of F9, namely at 5.33 seconds.

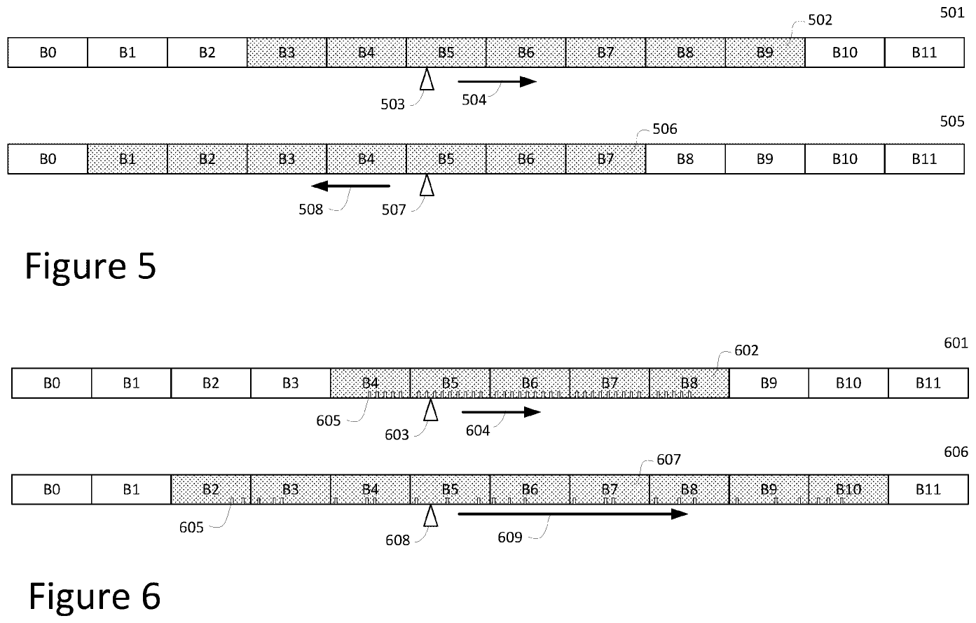

Reference is now made to FIG. 5, which shows how the pre-decode cache module 302 may allocate memory to GOP data blocks based on a current playback status. The drawings show a sequence of twelve blocks 501 individually identified as B0 through B11. The pre-decode cache 302 has allocated memory such that it stores blocks B3 through B9, shown as the shaded area 502. This allocation has been determined based on a current playback time 503 in block B5 and a current playback direction and speed indicated by the arrow 504.

This means that two blocks B3, B4 that are in the past with respect to the current playback position 503 and direction 504 and four blocks B6, B7, B8, B9 that are in the future are cached. If playback direction changes, as shown for the same twelve blocks 505 with the same playback position 507 but the opposite playback speed and direction 508, the pre-decode cache 302 may instead determine that B1 through B7 should be stored, as indicated by the shaded area 506. The allocation of memory and the determination of which blocks to include in memory in the pre-decode cache may be based on long term prediction of playback direction and speed, current position, and available network bandwidth. This determination may be applied to which segments to request from the parser 104, which blocks to store when they are received from the stream analyzer 301, and also which blocks to remove from cache in order to clear memory. Both cases show seven blocks stored in memory. It should be noted that this is for illustration purposes. The pre-decode cache will typically cover a longer time period, for example somewhere between 500 milliseconds and 4000 ms, and this may be dynamically changed based, for example, on playback speed and network bandwidth.

FIG. 6 is a similar illustration of memory allocation in the post-decode cache 303. The two examples shown here are both based on a playback status with the same playback direction, but with different playback speed. The first example shows twelve blocks 601 individually identified as B0 through B11. Frames 605 from five blocks 602, blocks B4 through B8, are present in post-decode cache. The current playback position, or playback time 603, is shown, and so is the current playback speed and direction 604.

The second example again shows twelve blocks 606 numbered B0 through B11. In this example the cache 607 spans over nine blocks, B2 through B10 even though the playback position 608 is the same as in the previous example. The reason is that the playback speed 609 is three times higher than previously. It will be seen that the frames that are dropped do not have to have the same position in the respective blocks. This is because, as discussed above, referenced frames that are needed in order to decode other frames, are prioritized, and which frames are referenced does not have to be the same in each block.

Since the cache now stores fewer frames from each block, less memory is used by each block, which means that it becomes possible to expand the period of time covered by the cache. Some embodiments may in addition dynamically change the amount of memory that is allocated to storing frames in post-decode cache 303.

This also illustrates the need for the DecodedFrames mask, the bitmask showing which of the frames from a GOP data block are actually present in post-decode cache. If playback were suddenly to slow down it would be necessary to request the missing frames from the blocks in cache 607, and this would also require clearing of the blocks that are more distant from the current playback position 608 in order to make memory available for the newly requested frames. Frames that are already in the decoder, as indicated by the inDecoderMask do not have to be requested again, but other missing frames will have to be requested. This can be done by setting the decode bitmask and sending a request message from the post-decode cache module 303 to the pre-decode cache module 302 as described above.

It should be noted that while the I-frame of each GOP will have to be decoded in order for the rest of the frames to be decoded, the I-frame may be dropped subsequent to decoding, i.e. from the output of the video decoder 104, or as a result of frames being selectively deleted from the post-decode cache. Other referenced frames may be similarly dropped or deleted from cache. In some embodiments the referenced frames that are available in post-decode cache 303 may be made available to the video decoder 104 when additional frames from the same GOP data block are requested. In embodiments where this is not possible, it becomes necessary to also request all necessary referenced frames even if they are already present in post-decode cache 303.

Another reason for dropping frames is a result of the fact that the post-decode cache 303 may have a limited amount of memory available. This means that the cache may not be able to store all frames from the first and the last GOP data block covered. This is illustrated in FIG. 6 where in the first example 602 the first block B4 includes only the last few frames and the last block B8 includes only the first few frames. In the case of B4 this means that the I-frame and probably several other referenced frames will have to be dropped after decoding. The situation is the same in the second example 606. Consequently, in order to establish the situation shown in the two examples it is necessary to go back to the beginning of B4 and B2, respectively, decode all frames necessary for decoding, and subsequently drop the frames that there are not room for in cache. This is something the post-decode cache must take into consideration when determining how to set the decode mask.

As with the pre-decode cache 302 allocation of memory in the post-decode cache may be based on current playback status and prediction. In embodiments where the amount of memory allocated is fixed, memory allocation is the same as deciding which frames to request from the pre-decode cache 302 and deciding which frames to drop or clear from cache. The current playback status may be based on such parameters as a current playback position in the video stream, which may be expressed as a current playback time, the unique identification of a currently displayed video frame, a current playback speed, a current playback direction, and received user input requesting a change in at least one of the currently displayed video frame, the current playback speed, and the current playback direction. Received user input may include input that has just been received and not yet or just recently been implemented, but also user input over a period of time, for example by correlating different user input with previously received sequences of user input or by correlating previously received user input with specific positions in the video stream.

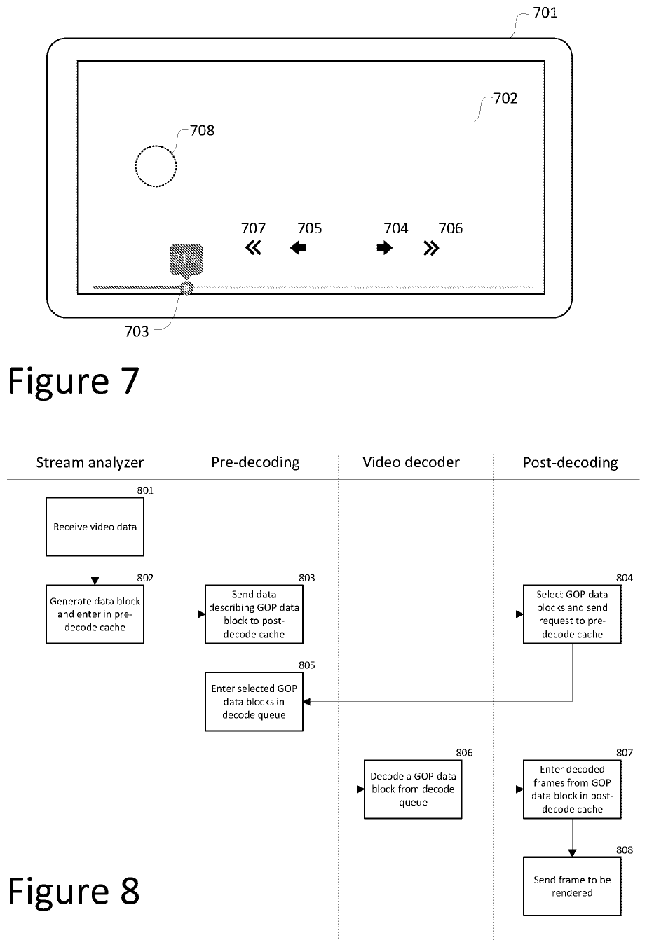

Returning briefly to FIG. 3, a video player device where flow of data through the decoder is controlled in accordance with the invention may include a user input system 305 including a user interface 306, an input recognition module 307, and a predictor 308. FIG. 7 shows an example of a video player device in the form of a handheld unit 701 which may be a smartphone or some similar device. This device includes a display 702 which may be a touch display constituting part of, or being connected to, the user interface 306. The display shows a number of user control elements that a user can interact with in order to control the playback of video content. A first such element is a progress bar with a slider 703. The user may user a finger to slide the slider to the right or to the left in order to rapidly move forward or backward through the video content. Such an operation would be interpreted by the input recognition module 307 as an instruction to rapidly change the playback position in one direction or the other.

A set of four similar user control elements include a play forward button 704, a play backward button 705, a fast-forward button 706 and a fast-backward button 707. If a user touches one of these elements it may be interpreted by the input recognition module 307 as an instruction to set playback speed to x1 forward, x1 backward, x3 forward, and x3 backward, by way of example. Holding or repeatedly tapping the fast-forward 706 or fast-backward 707 controls could be interpreted as a command to cycle through a number of available speeds.

An additional user control element 708 is not visible on the display 702 but indicated as a dashed circle. This represents how users may be able to place a finger on the display 702 and move the finger to the left or to the right in order to control playback speed and direction. Holding the finger still could be interpreted as a command to freeze playback, while moving the finger slowly or fast could result in correspondingly slow or fast playback speeds. Swiping could be interpreted based on a physics model which would cause the video to start playing rapidly in the direction of the swipe and gradually slowing down towards normal playback speed.

The input recognition module 307 may, in order to be able to interpret such user gestures, include a kinetic simulator which simulates time based on a physical model and calculates new playback position and speed based on amount of movement per fixed intervals of time and Euler integration.

An embodiment of the invention may include none, some or all of these controls, and they are intended as examples which do not preclude inclusion of different types of controls instead or in addition to the ones described.

The prediction module, or predictor 308 is configured to generate the estimates needed to determine which content to request, in terms of segments and GOPs for the pre-decode cache 302 and in terms of GOP data blocks and video frames for the post-decode cache. The predictor may estimate long term and short-term playback speeds, likelihood of change in playback direction and speed.

The prediction generated by the predictor 308 is provided to the two stream controllers 308, 309 and the frame selector 304. The stream controllers may forward or control the respective cache modules 302, 303 based on this prediction. As already mentioned, the pre-decode cache 302 operates in accordance with a long-term prediction of playback speed and direction, for example 500-4000 ms, while the post-decode cache 303 operates in accordance with a short-term prediction covering for example 100-1000 ms. The following is a simple process for prioritizing caching of frames in the post-decode cache 303.

The current block is the GOP block from which the currently displayed video frame originated. The highest priority should now be given to the closest neighboring block. This is determined based on the beginning of the next block and the end of the previous block based on normal playback direction.

When it is determined which block has the highest priority it is determined which frames from this block that are needed. This is determined by predicted playback speed, and by considering the ReferencedMask for this block. If any of these frames are already present in the post-decode cache, they may be assigned protected status in a data structure that identifies frames that should be protected from deletion from the cache. The availability mask can now be generated, and frames that required but not identified in the availability mask may be set in the decode mask. A GOP data block request and an associated decode mask may now be sent in a message to the pre-decode cache.

The process may select the next GOP block by identifying the closest block when the block just requested is excluded (i.e. the second closest block). If the blocks are of the same or substantially same size and the playback time has not progressed too much during identification and request of the previous block, this will normally be the block on the opposite side of the current block from the block with the highest priority. However, if GOP length in terms of duration is allowed to vary, or if playback position has progressed significantly the GOP block adjacent to the previously requested block may be next.

This process may continue until the cache is full. After the cache is full the process will restart as soon as the playback position has changed significantly, or playback speed changes.

This process may be further refined by taking playback direction into consideration, by giving higher priority to blocks that the current playback direction moves towards. This higher priority may be a function of direction change probability. The higher the estimated probability of a direction change, the less priority should be given to blocks that are downstream in the current playback direction.

The process described above explains how GOP data blocks and individual frames can be selected to be requested from the pre-decode cache 302 but does not specify when requests should be sent. In principle, any method that ensures requests are sent timely and result in a post-decode cache 303 where the required content is available when needed, may be implemented while remaining within the scope of the invention. The simplest, most straightforward method would be to send a message from the pre-decode cache to the post-decode cache each time a new GOP data block is delivered to the pre-decode cache 302 and to request a new GOP data block, with a given decode mask, each time a next required GOP data block has been identified as having highest priority and provided that there is sufficient space available in post-decode cache memory.

However, this would require a separate message request for each individual data block, and this may be unnecessary. Instead it may be more efficient to fill up the entire post-decode cache in accordance with determined priorities based on one single message that identifies all requested GOP data blocks as well as all required/dropped frames, as specified by the decode mask for the respective data blocks. A new request may then only be sent when the playback status changes sufficiently. One or more conditions may be defined as a sufficient change in playback status to restart the process of updating the post-decode cache 303.

One such condition may be that the playback position 603, 608 progresses towards the end of the content currently held in post-decode cache 303. This may be defined as a certain distance from the end of the cache measured in time at the given playback speed, a certain percentage of the total amount held in post-decode cache memory, or a certain number of GOP data blocks. In the example illustrated in the first sequence of blocks 601 in FIG. 6 the distance may, for example, be one data block at normal playback speed, meaning that when playback position 603 progresses into block B8 the cache content is refreshed. Similarly, if playback direction were to change, cache content would be refreshed when the playback position started rendering content from block B4. In the second sequence of blocks 602, at triple playback speed, the refreshing of cache may start, for example, two blocks from the end of the cached content, which means upon entry of block B9 in the forward direction and block B3 in the backward direction.

Upon cache refresh the post-decode cache 303 will select GOP data blocks based on updated priorities, as described above but based on the new playback position and status, and request all GOP data blocks that are required and not already available in post-decode cache memory. At the same time, content that is outside the required cache content will be designated as unprotected, e.g. they will no longer be identified as protected in the data structure that protects frames from deletion from cache. It may not be necessary to delete such content directly. Instead, unprotected content may be overwritten when the memory is required.

A GOP data block will be identified as required if it is identified as prioritized using the method described above, based on such parameters as distance from current playback position, playback direction and playback speed, and provided that it is not already present in post-decode cache. If the GOP data block is present in post-decode cache, but only with a subset of its frames, it will still be required if some of the missing frames are required, but it may be sufficient to set the bits representing the missing required frames in the decode bitmask.

When all required GOP data blocks and their respective required subset of frames have been determined, all this information may be included in one request message that is sent back to the pre-decode cache 302. The message may prioritize GOP data blocks such that GOP data blocks are entered in the decode queue in accordance with this prioritization.

Similarly to the way requests for several GOP data blocks are included in one message from the post-decode cache module 303 to the pre-decode cache module 302, the message from the pre-decode cache module 302 to the post-decode cache module 303 identifying a GOP data block that has been entered into pre-decode cache may be sent less frequently and include a list of more than one GOP data block.

FIG. 8 is a flowchart summarizing the flow of data described above. In a first step 801 video data is received by the stream analyzer 301 after having passed through the input cache 103, parser 104, and demuxer 105. The stream analyzer, in step 802, generates GOP data blocks and adds data and data structures that describe the GOP data block, such as presentation to decode map, referenced mask, decode mask and frame durations. The finished GOP data blocks are entered in the pre-decode cache 302. In step 803 processing is taken over by the pre-decoding cache module 302 which sends data describing a received GOP data block to the post-decode cache module 303.

The post-decode cache module 303 may now, in step 804, select one or more, as discussed above, of the GOP data blocks about which it has received information and send a request for that GOP data block back to the pre-decode cache module 302. In step 805 the selected GOP data blocks are entered in a decode queue in the pre-decode cache. In step 806 the frames of the GOP decode block at the head of the decode queue is delivered to the video decoder 106 in decode order and decoded.

The decoded frames are delivered from the video decoder 106 to the post decode cache 303 in step 807. In step 808 frames are fetched from the post-decode cache 303 by the frame selector 304 and forwarded to the renderer 108.

It will be understood that the flow of information illustrated in FIG. 8 is continuously ongoing, and not intended to illustrate steps that are finished before a process moves on to the next step. As such, video data may be continuously received, resulting in a continuous stream of data blocks from the stream analyzer to the pre-decoding cache, and a corresponding stream of information regarding available data blocks from the pre-decoding stage to the post-decoding stage. Selection of GOP data blocks to be requested by post-decoding stage may be based on current playback status, including playback position, speed, direction, and the content already present in post-decode cache.

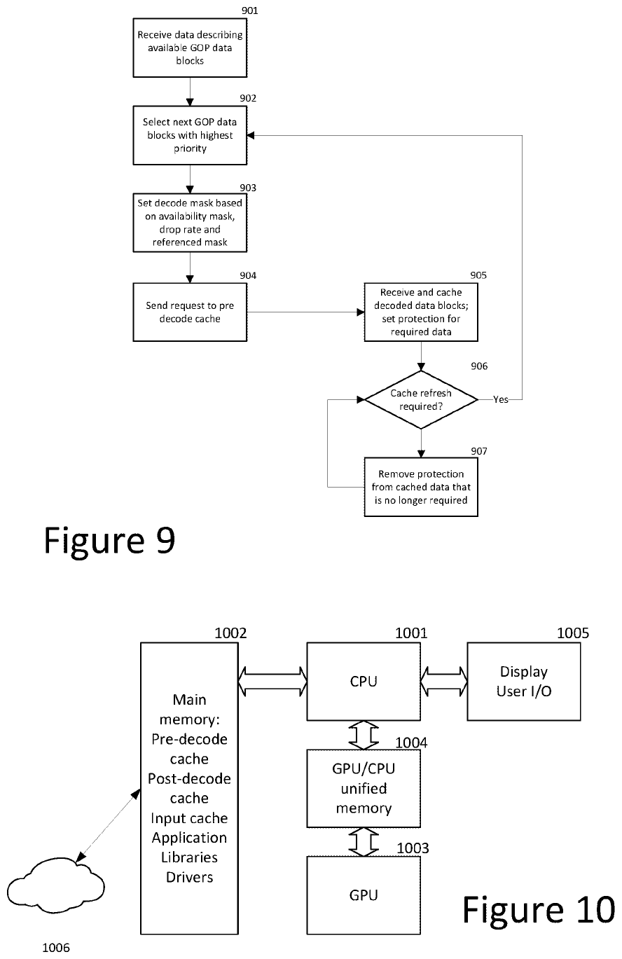

FIG. 9 is a flow chart illustrating the selection of GOP data blocks and frames to be requested by the post-decode cache 303 in further detail. The steps illustrated in FIG. 9 are substantially a detailed description of step 804 in FIG. 8.

In a first step 901 the post-decode cache 303 receives data describing available GOP data blocks in the pre-decode cache 302. This information may be received as individual messages from the pre-decode cache 302 whenever a GOP data block is received from the stream analyzer 302, or less frequently as a list of several added GOP data blocks. Step 901 is repeated continuously while the following steps are performed, such that the post-decode cache can maintain updated information about data blocks available from the pre-decode cache. In step 902 the next GOP data blocks to be requested are selected based on a determination of priority and exclusion of already cached content and of frames that should be dropped, as already described. After it has been determined in step 902 that a given GOP data block is required it should also be determined which frames in the selected GOP data block to include or drop by setting the appropriate bits in the decode mask. If all required frames from a GOP data block are already available, i.e. either already stored in post-decode cache 303 or currently being decoded by the video decoder 106, it is not necessary to request a selected data block.

Thus, for a GOP data block that is not already available (i.e. in the decoder or in post-decode cache), or available but from which required frames are missing, the decode mask is set in step 903. This constitutes selecting a subset of the frames in the GOP data block based on the principles described above, including whether the frame is already available (do not include), whether the frame is referenced by other frames (prioritize), and whether playback speed is high enough to require that frames are dropped (drop frames starting with non-referenced frames). A request for the selected GOP data blocks modified by their respective decode masks can now be sent to the pre-decode cache 302 in step 904.

The requested data blocks, excluding frames that were designated to be dropped, are received in step 905 and stored in the post-decode cache module 303. The data structure identifying protected cache content may now be updated to signify protected status for the data that has just been received. While this process is performed, playback continues and the playback status changes. This means that sooner or later it will be necessary to refresh the content of the post-decode cache. As described above, the specific method or requirement for determining that a cache refresh is necessary may vary in different embodiments. As long as cache refresh is not required, as determined in step 906, the process may simply wait. During this wait, and as playback status progresses, protection may be removed in step 908 from cached content that is no longer required. This process serves to make cache memory available for incoming data. When it is finally determined, in step 907, that a cache refresh is required, the process may return to step 902 to determine which GOP data blocks are required based on the new playback status and new information regarding available data blocks from the continuously running step 901.

According to the aspects and embodiments described above, GOP data blocks and frames are selected and requested based on a current playback status which may include playback speed and direction and user input. However, some embodiments of the invention allow the playback status to be prerecorded or pre-generated as a remix of the original video stream. In such embodiments, playback status parameters may have been registered during one or more previous playbacks of the same stream of video data, or registered or created by other means capable of generating a remix of positions and speed in a video stream based on user input, editing, analysis of content, etc. Positions in the original video stream may thus be registered in a file as a list of positions that should be accessed during a remixed playback. This may be implemented in a number of ways, e.g. simply be listing positions at which the playback speed or direction should be changed, as well as positions at which playback should jump to a different position.

In some embodiments the remix file includes an entry for every frame to display in the remix. This can be done by recording, or logging, positions at a certain interval, for example every 1/60 second. This is done while the video is played back based in accordance with the invention as described above, i.e. while allowing a user to accelerate, slow down, pause and restart the playback as well as changing direction of play. In other words, every 1/60s of the playback as controlled by the user will be registered with a time stamp representing the position in the original video stream that was being displayed at that point in time.

An example of what a number of entries in such a file may look like is shown in the table below.

| Tick | Time | Speed |
|---|---|---|
| 59 | 1:31.00 | 2x |
| 60 | 1:31.03 | 2x |
| 61 | 1:31.06 | 2x |
| 62 | 1:31.10 | 2x |
| 63 | 1:31.11 | 1x |

This list includes entries with a tick number, which is the number of 1/60s steps into the remix, a time stamp, which represents a position in the original video stream, and an indication of the playback speed at which the video was being played when the remix file was recorded. In this example it can be seen that the time progresses with 2/60 second per tick as a result of the double playback speed, except for the last entry shown, which represents a progression of only 1/60 second, and a reduction to normal playback speed.

In embodiments with the capability of playing back remixes like this, the current playback status which determines which GOP data blocks and frames to request, is solely determined by the remix file.

The processing of data in the audio branch has not been discussed in particular detail above. In embodiments of the invention audio data may be subject to caching in data blocks that correspond to GOP data blocks in the video branch. This may facilitate synchronization and simplify management of the caches such that corresponding data are available with respect to both audio and video. Other embodiments may maintain a continuous stream of audio rather than creating data blocks and implement other methods for synchronizing audio and data. Audio data may also be processed in order to increase speed while maintaining pitch. Above a certain speed, and for playback in the reversed direction it may, however, be preferable to mute the audio.

FIG. 10 shows a block diagram of how a device implementing the invention may be configured. The device may include a CPU 1001 configured to perform most of the operations dictated by software and firmware modules stored in memory 1002. This memory may comprise not only main memory but also hard drives, flash drive, and other forms of volatile and persistent memory, and may hold data included in the pre-decode cache 302 and post-decode cache 303 as well as the input cache 103 and the software parts of other modules such as the parser 104, the demuxer 105, the stream analyzer 301, the video decoder 16, the stream controllers 308, 309, frames selector 304, video renderer 108 and user input system 305. These modules may also include hardware components that are not shown in the drawing, just like other general-purpose hardware components are not shown. The memory 1002 may also include libraries and drivers. A graphics processor unit (GPU) 1003 may be included and operate in coordination with the CPU and under control of the video decoder 106. The CPU 1001 and the GPU 1003 may share a common memory area 1004 with unified address space. Finally, the device may include a display 1005 which may be a touch display that also operates as part of the user input system 305.

The invention is, of course, not limited to embodiments with one CPU and one GPU. In its simplest embodiments only one processor is used and all functionality is handled by this processor alone. Other possibilities include additional processors, multicore processors, APU's, DSP's etc.

The device may receive data from a network 1006 to which it is connected, but it may also be configured to be able to store and display content locally.

A computer program product may be embedded or stored in a computer readable medium and include instructions that, when transferred to a computing device with a processor, enables the processor to perform the instructions and thereby utilize the resources of the device to perform the method described above, and thereby constitute a device consistent with the principles of the invention.

The invention has been described by way of examples and it is consistent with the principles of the invention to modify, adjust and reconfigure various aspects. By way of example, the stream controllers have been described as separate components, but they may equally well be implemented as parts of the pre-decode cache module and the post-decode cache module. Alternatively, the functionality described as part of the cache modules may equally well be implemented in or considered as being part of the stream controllers. Other functionality may also be distributed between components or modules in different ways. As such, the reference to modules in the present disclosure and the appended claims, particularly with respect to the pre-decode cache module and the post-decode cache module, is a reference to a set of functions that are implemented to be performed in embodiments of the invention, and not a description of the structure or architecture of the various embodiments that are possible. Consequently, the pre-decode cache module and the post-decode cache module may be implemented as different functions in a single flow control module, or they can be implemented as separate processes in separate modules. The pre-decode cache module should thus be understood as the parts of a device that stores, manages, and makes information available about the compressed data stored in cache and available to the decoder, and the post-decode cache module should be understood as the parts of a device that stores, manages, and makes information available about the decoded data stored in cache and available to be rendered. The same is the case for other modules described herein.

Similarly, except to the extent that the output of one step is a precondition for the performance of a following step, steps do not have to be performed in the sequence described in the examples. In particular, the generation of the decode mask takes into consideration several different factors including how many frames to drop, which frames are available in post-decode cache, which frames are being processed by the decoder, and which frames are referenced by other frames—and possibly also how many frames does the cache have room for. The sequence of considering these different factors may be chosen arbitrarily and any description of a particular sequence herein is not intended to imply that the steps must be performed in that sequence.

It will be understood that the invention involves aspects that while they all contribute towards the realization of a video decoding device which enables improved user interaction with video content, different subsets of features contribute in different ways towards this end. The applicant reserves the right to, in a divisional application, pursue protection of aspects that are not covered by the appended claims.

1. A method of managing the flow of data through a video decoder, comprising:
receiving a stream of video data including compressed video frames organized in groups-of-pictures (GOP) with one intra-frame coded image and a plurality of inter-frame coded images;
entering data included in received GOPs as uniquely identified GOP data blocks with uniquely identified compressed video frames in a pre-decode cache module (302);
selecting, based on a current playback status, a uniquely identified GOP data block that has been entered in the pre-decode cache module (302) and appending the selected GOP data block to a decode queue for GOP data blocks that will be delivered as input to a video decoder (106); and
entering data from decoded GOP data blocks delivered as output from the video decoder (106) as decoded video frames in a post-decode cache module (303).

2. A method according to claim 1, wherein
the selection of which GOP data block to append to the decode queue is made by comparing information about available GOP data blocks currently stored in the pre-decode cache module (302) with the current playback status and by providing an instruction to the pre-decode cache module (302) identifying the selected GOP data block.

3. A method according to claim 1, wherein the selection of which GOP data block to append to the decode queue is performed each time a pre-defined criterion for a post-decode cache refresh is fulfilled, and that multiple GOP data blocks are selected and appended to the decode queue when the post-decode cache refresh is performed.

4. A method according to claim 1, wherein the current playback status includes one or more parameters selected from the group consisting of: a current playback position in the video stream, a unique identification of a currently displayed video frame, a current playback speed, a current playback direction, received user input requesting a change in at least one of the currently displayed video frame, the current playback speed and the current playback direction, and playback status parameters stored in a remix file prior to a currently ongoing decoding of the stream of video data.

5. A method according to claim 1, wherein the selection of a uniquely identified GOP data block includes a selection of a subset of the uniquely identified compressed video frames in the GOP data block, the method further comprising causing the video decoder (106) to drop video frames from the GOP data block if they are not included in the selected subset.

6. A method according to claim 5, wherein the size of the subset of the uniquely identified compressed video frames in the GOP data block is reduced when the current playback speed is increased.

7. A method according to claim 5, wherein when uniquely identified compressed video frames are selected to be included in the subset, referenced video frames that are required for the decoding of referencing video frames in the same GOP are prioritized, and video frames that are already available in the post-decode cache (303) or currently being processed by the video decoder (106) are excluded.

8. A method according to claim 1, wherein the selection of a uniquely identified GOP data block that has been entered in the pre-decode cache module (302) to be appended to the decode queue for GOP data blocks that will be delivered as input to a video decoder (106), is based on a priority that is increased as a function of one or more of the following: the absence of required decoded video frames belonging to the GOP data block from the post-decode cache (303), the distance in time between a current playback time and the closest of the beginning and the end time of the GOP data block, a current playback direction, and an estimate of the likelihood of a change in playback direction.

9. A method according to claim 1, further comprising:
analyzing the received stream of video data and organizing data related to the same GOP as uniquely identified GOP data blocks with uniquely identified compressed video frames, wherein data resulting from the analysis of the received stream of video data is embedded in the GOP data blocks when they are entered in the pre-decode cache module (302) and include information selected from the group consisting of:
a GOP start time,
a GOP duration,
a GOP end time,
a video frame start time for each video frame,
a video frame duration for each video frame,
a video frame end time for each video frame,
a data array correlating video frame decode sequence with video frame presentation sequence and,
a data structure identifying referenced video frames that are required for decoding referencing video frames in the same GOP.

10. A method according to claim 1, wherein memory allocated to storing GOP data blocks in the pre-decode cache module (302) is dynamically allocated to GOP data blocks from before and after the current playback position based on one or more of a current playback direction, a current playback speed, and a long-term prediction of the likelihood of change in playback direction or playback speed; and
memory allocated to storing decoded video frames in the post-decode cache module (303) is dynamically allocated to decoded video frames from before and after the current playback position based on one or more of a current playback direction, a current playback speed, and a short term prediction of the likelihood of change in playback direction or playback speed.

11. A video decoding device comprising:
an input interface capable of receiving a stream of video data including compressed video frames organized in groups-of-pictures (GOP) with one intra-frame coded image and a plurality of inter-frame coded images;
a stream analyzer (301) configured to format data included in received GOPs as uniquely identified GOP data blocks with uniquely identified compressed video frames;
a pre-decode cache module (302) including a memory (1002) and configured to receive and store uniquely identified GOP data blocks and maintain a queue of such GOP data blocks to be decoded;
a video decoding module (106) including a processor (1001, 1003);
a post-decode cache module (303) including a memory (1002) and configured to receive data including decoded GOP data blocks delivered as output from the video decoder (106) and to store the received decoded data blocks as decoded video frames in the post-decode cache module (303) memory (1002); and wherein
the post-decode cache module (303) is further configured to select, based on a current playback status, a uniquely identified GOP data block that has been entered in the pre-decode cache module (302) and cause the selected GOP data block to be appended to the decode queue for GOP data blocks that will be delivered as input to a video decoder (106).

12. A video decoding device according to claim 11, wherein the pre-decode cache module (302) is further configured to make information describing the content of a GOP data block available to the post-decode cache module (303) when the GOP data block is received by the pre-decode cache module (302) from the stream analyzer (301); and
the post-decode cache module (303) is further configured to make the selection of which GOP data block to append to the decode queue by comparing received description of GOP data blocks with the current playback status and issuing an instruction identifying the selected GOP data block.

13. A video decoding device according to claim 11, wherein the post-decode cache module (303) is further configured to make the selection of which GOP data block to append to the decode queue is performed each time a pre-defined criterion for a post-decode cache refresh is fulfilled, and that multiple GOP data blocks are selected and appended to the decode queue when the post-decode cache refresh is performed.

14. A video decoding device according to claim 11, wherein the current playback status the post-decode cache module (303) compares with received descriptions of GOP data blocks includes one or more parameters selected from the group consisting of: a current playback position in the video stream, a unique identification of a currently displayed video frame, a current playback speed, a current playback direction, received user input requesting a change in at least one of the currently displayed video frame, the current playback speed and the current playback direction, and playback status parameters stored in a remix file prior to a currently ongoing decoding of the stream of video data.

15. A video decoding device according to claim 11, wherein the post-decode cache module (303) is further configured to limit the selection of a uniquely identified GOP data block to a selected subset of the uniquely identified compressed video frames in the GOP data blocks, and the video decoder (106) is further configured to drop video frames from the GOP data block if they are not included in the selected sub set.

16. A video decoding device according to claim 15, wherein the post-decode cache module (303) is configured to reduce the size of the subset of the uniquely identified compressed video frames in the GOP data block when the current playback speed is increased.

17. A video decoding device according to claim 15, wherein the post-decode cache module (303) is further configured to, when limiting the selection of a subset of video frames from a GOP data block, prioritize referenced video frames that are required for the decoding of referencing video frames in the same GOP, and exclude video frames that are already available in the post-decode cache or currently being processed by the video decoder (106).

18. A video decoding device according to claim 12, wherein the post-decode cache (303), when making the selection of a uniquely identified GOP data block that has been entered in the pre-decode cache module (302) to be appended to the decode queue for GOP data blocks that will be delivered as input to a video decoder (106), is configured to prioritize GOP data blocks such that priority is increased based on one or more of the following: the absence of required decoded video frames belonging to the GOP data block from the post-decode cache, the distance in time between a current playback time and the closest of the beginning and the end time of the GOP data block, the current playback direction, and an estimate of the likelihood of a change in playback direction.

19. A video decoding device according to claim 11, wherein the stream analyzer (301) is further configured to analyze the received stream of video data and organize data related to the same GOP as uniquely identified GOP data blocks with uniquely identified compressed video frames, and to embed the data resulting from the analysis of the received stream of video data in the GOP data blocks when they are entered in the pre-decode cache module (302), wherein the embedded data includes information selected from the group consisting of:
a GOP start time,
a GOP duration,
a GOP end time,
a video frame start time for each video frame,
a video frame duration for each video frame,
a video frame end time for each video frame,
a data array correlating video frame decode sequence with video frame presentation sequence and,
a data structure identifying referenced video frames that are required for decoding referencing video frames in the same GOP.

20. A video decoding device according to claim 11, wherein the pre-decode cache module (302) is configured to dynamically allocate memory to GOP data blocks from before and after the current playback position based on one or more of a current playback direction, a current playback speed, and a long-term prediction of the likelihood of change in playback direction or playback speed; and
the post-decode cache module (303) is configured to dynamically allocate memory to decoded video frames from before and after the current playback position based on one or more of a current playback direction, a current playback speed, and a short term prediction of the likelihood of a change in playback direction or playback speed.

21. A computer program product embedded in a computer readable medium and including instructions allowing a device to perform a method in accordance with claim 1 when executed by a processing unit in the device.
